(19) United States
(12) Patent Application Publication
(10) Pub. No.: US 2026/0362377 A1
(43) Pub. Date: Nov. 12, 2026

(54) WIRELESS COMMUNICATION METHOD, TERMINAL DEVICE AND COMMUNICATIONS DEVICE

(71) Applicant: QUECTEL WIRELESS SOLUTIONS CO., LTD., Shanghai (CN)

(72) Inventor: Zheng ZHAO, Shanghai (CN)

(73) Assignee: QUECTEL WIRELESS SOLUTIONS CO., LTD., Shanghai (CN)

(21) Appl. No.: 19/488,432

(22) PCT Filed: Dec. 22, 2023
(86) PCT No.: PCT/CN2023/141269

§ 371 Date: Apr. 9, 2026

(51) Int. Cl. H04W 64/00; H04B 17/21; H04L 5/00; H04W 8/22; H04W 84/06

(52) U.S. Cl. CPC H04W 64/00; H04B 17/221; H04L 5/0051; H04W 8/22; H04W 84/06

(57) ABSTRACT

A wireless communication method, a terminal device, and a communications device are provided. The method includes: transmitting, by a first device, a first signal and a second signal to a first terminal device, where a relationship between a phase of the first signal and a phase of the second signal on a side of the first device is a first relationship, the first signal and the second signal are used for determining first phase information, the first phase information includes a receive phase difference between the first signal and the second signal on a side of the first terminal device, a location at which the first device transmits the first signal is a first location, a location at which the first device transmits the second signal is a second location, and the first location and the second location are different. The receive phase difference may be calculated according to the relationship (that is, the first relationship) between the first signal and the second signal on the transmit side, so that the calculated receive phase difference is more accurate.

### TECHNICAL FIELD

The present application relates to the field of communications technologies, and more specifically, to a wireless communication method, a terminal device, and a communications device.

### BACKGROUND

During positioning, a more accurate distance between a signal transmitting party and a signal receiving party can be obtained by measuring phase information of a received signal. During phase estimation, a phase of a signal may be affected by factors such as noise and transmit-end and receive-end hardware processing, resulting in inaccurate phase estimation. Based on related technologies, it is difficult to eliminate impact of a transmit end on phase measurement. To eliminate impact of factors such as a clock difference, a hardware delay, and an initial phase of the transmit end on phase measurement, and obtain an accurate phase measurement result, a signal of the transmit end needs to be configured.

### SUMMARY

The present application provides a wireless communication method, a terminal device, and a communications device. Various aspects involved in the present application are described below.

According to a first aspect, a wireless communication method is provided. The method includes: transmitting, by a first device, a first signal and a second signal to a first terminal device, where a relationship between a phase of the first signal and a phase of the second signal on a side of the first device is a first relationship, the first signal and the second signal are used for determining first phase information, the first phase information includes a receive phase difference between the first signal and the second signal on a side of the first terminal device, a location at which the first device transmits the first signal is a first location, a location at which the first device transmits the second signal is a second location, and the first location and the second location are different.

According to a second aspect, a wireless communication method is provided. The method includes: receiving, by a first terminal device, a first signal and a second signal that are transmitted by a first device, where a relationship between a phase of the first signal and a phase of the second signal on a side of the first device is a first relationship, the first signal and the second signal are used for determining first phase information, the first phase information includes a receive phase difference between the first signal and the second signal on a side of the first terminal device, a location at which the first device transmits the first signal is a first location, a location at which the first device transmits the second signal is a second location, and the first location and the second location are different.

According to a third aspect, a communications device is provided. The communications device is a first device. The communications device includes: a first transmitting unit, transmitting a first signal and a second signal to a first terminal device, where a relationship between a phase of the first signal and a phase of the second signal on a side of the first device is a first relationship, the first signal and the second signal are used for determining first phase information, the first phase information includes a receive phase difference between the first signal and the second signal on a side of the first terminal device, a location at which the first device transmits the first signal is a first location, a location at which the first device transmits the second signal is a second location, and the first location and the second location are different.

According to a fourth aspect, a terminal device is provided. The terminal device is a first terminal device. The terminal device includes: a first receiving unit, receiving a first signal and a second signal that are transmitted by a first device, where a relationship between a phase of the first signal and a phase of the second signal on a side of the first device is a first relationship, the first signal and the second signal are used for determining first phase information, the first phase information includes a receive phase difference between the first signal and the second signal on a side of the first terminal device, a location at which the first device transmits the first signal is a first location, a location at which the first device transmits the second signal is a second location, and the first location and the second location are different.

According to a fifth aspect, a communications device is provided. The communications device includes a processor and a memory. The memory is configured to store one or more computer programs, and the processor is configured to invoke the computer program in the memory to cause the communications device to execute a part or all of the steps of the method in the first aspect.

According to a sixth aspect, a terminal device is provided, and includes a processor and a memory. The memory is configured to store one or more computer programs, and the processor is configured to invoke the computer program in the memory to cause the terminal device to execute a part or all of the steps in the method in the second aspect.

According to a seventh aspect, an embodiment of the present application provides a communications system. The system includes the foregoing terminal device and/or the foregoing communications device. In another possible design, the system may further include another device that interacts with the terminal device or the communications device in the solutions provided in embodiments of the present application.

According to an eighth aspect, an embodiment of the present application provides a computer-readable storage medium. The computer-readable storage medium stores a computer program. The computer program causes a terminal device and/or a communications device to execute a part or all of the steps of the method in the foregoing aspects.

According to a ninth aspect, an embodiment of the present application provides a computer program product. The computer program product includes a non-transitory computer-readable storage medium that stores a computer program. The computer program is operable to cause a terminal device and/or a communications device to perform a part or all of the steps of the method in the foregoing aspects. In some implementations, the computer program product may be a software installation package.

According to a twelfth aspect, an embodiment of the present application provides a chip. The chip includes a memory and a processor, and the processor may invoke and run a computer program in the memory, to implement some or all of the steps of the methods according to the foregoing aspects.

For a same device, some delays that affect phase estimation on a transmit end are relatively constant, for example, a hardware delay. Therefore, it may be considered that these delays of the first device substantially maintain unchanged at an instant of transmitting the first signal and an instant of transmitting the second signal. Through difference calculation on a receive end, impact of a relatively constant delay of the transmit end on a phase can be eliminated. In addition, the receive phase difference may be calculated with reference to the relationship (that is, the first relationship) between the first signal and the second signal on the transmit side, so that the calculated receive phase difference is more accurate.

### BRIEF DESCRIPTION OF THE DRAWINGS

FIG. 1 is a schematic diagram of a wireless communications system to which an embodiment of the present application is applied.

FIG. 2 is a schematic flowchart of a wireless communication method according to an embodiment of the present application.

FIG. 3 is a schematic structural diagram of a communications device according to an embodiment of the present application.

FIG. 4 is a schematic structural diagram of a terminal device according to an embodiment of the present application.

FIG. 5 is a schematic structural diagram of an apparatus for communication according to an embodiment of the present application.

### DESCRIPTION OF THE EMBODIMENTS

The technical solutions in the present application are described below with reference to the accompanying drawings.

### Communications system

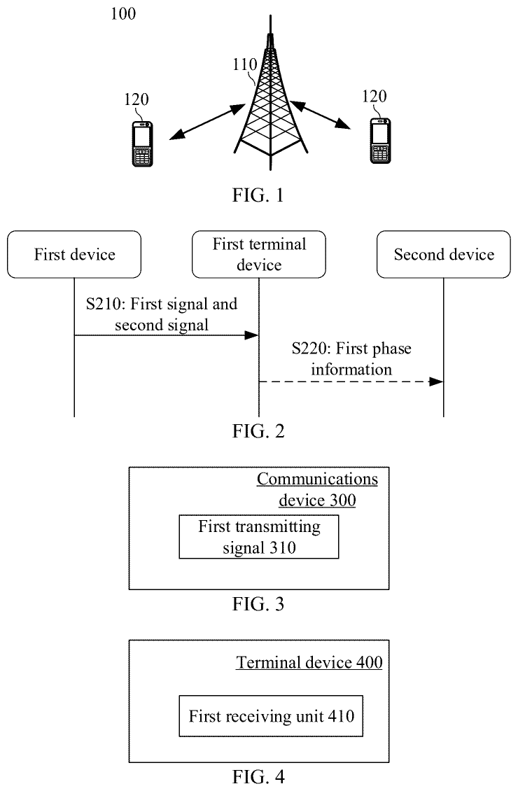

FIG. 1 shows a wireless communications system 100 to which an embodiment of the present application is applied. The wireless communications system 100 may include a communications device. The communications device may include a network device 110 and a terminal device 120. The network device 110 may be a device that communicates with the terminal device 120.

FIG. 1 schematically shows one network device and two terminals. Optionally, the wireless communications system 100 may include a plurality of network devices, and another quantity of terminal devices may be included within coverage of each network device. This is not limited in embodiments of the present application.

Optionally, the wireless communications system 100 may further include other network entities such as a network controller and a mobility management entity. This is not limited in embodiments of the present application.

It should be understood that the technical solutions of embodiments of the present application may be applied to various communications systems, such as a 5th generation (5G) system or a new radio (NR) system, a long-term evolution (LTE) system, an LTE frequency division duplexing (FDD) system, and an LTE time division duplexing (TDD) system. The technical solutions provided in the present application may further be applied to a future communications system, such as a 6th generation mobile communications system or a satellite communications system.

The terminal device in embodiments of the present application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone, a tablet computer (Pad), a notebook computer, a palmtop computer, a mobile Internet device (MID), a wearable device, a virtual reality (VR) device, an augmented reality (AR) device, a wireless terminal in industrial control (industrial control), a wireless terminal in self driving, a wireless terminal in remote medical surgery, a wireless terminal in a smart grid, a wireless terminal in transportation safety, a wireless terminal in a smart city, a wireless terminal in a smart home, or the like. Optionally, the UE may be configured to function as a base station. For example, the UE may function as a scheduling entity, which provides a sidelink signal between UEs in vehicle-to-everything (V2X), device-to-device (D2D), or the like. For example, a cellular phone and a vehicle communicate with each other by using a sidelink signal. A cellular phone and a smart home device communicate with each other, without relay of a communication signal through a base station.

The network device in embodiments of the present application may be a device configured to communicate with the terminal device. The network device may further include an access network device. The access network device may provide communication coverage for a specific geographic area, and may communicate with the terminal device 120 located in the coverage. The access network device may also be referred to as a radio access network device, a base station, or the like. The access network device in embodiments of the present application may be a radio access network (RAN) node (or device) that connects the terminal device to a wireless network. The access network device may broadly cover the following various names, or may be replaced with the following names, such as a NodeB, an evolved NodeB (eNB), a next generation NodeB (next generation NodeB, gNB), a relay station, an access point, a transmitting and receiving point (TRP), a transmitting point (TP), a master eNodeB (MeNB), a secondary eNodeB (SeNB), a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that assumes functions of a base station in D2D, V2X, and machine-to-machine (M2M) communications, a network-side device in a 6G network, a device that assumes functions of a base station in a future communications system, or the like. The base station may support networks with a same access technology or different access technologies. A specific technology and a specific device form used by the access network device are not limited in embodiments of the present application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

A communications device involved in a wireless communications system may include not only an access network device and a terminal device, but also a core network element. The core network element may be implemented by using a device, that is, the core network element is a core network device. It may be understood that the core network device may alternatively be a network device.

The core network element in embodiments of the present application may include a network element that processes and forwards signaling and data from a user. For example, the core network device may include a core network access and mobility management function (AMF), a session management function (SMF), a user plane gateway, a location management function (LMF), and other core network devices. The user plane gateway is typically located on a network side, and may be a server having functions such as mobility management, routing, and forwarding of user plane data, such as a serving gateway (SGW), a packet data network gateway (PGW), or a user plane function (UPF). Certainly, a core network may further include another network element. Examples are not listed here one by one.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or some of functions of the communications device in the present application may also be implemented by software functions running on hardware, or by virtualization functions instantiated on a platform (for example, a cloud platform).

### Non-Terrestrial network (NTN)

The NTN may provide a user with a communication service in a non-terrestrial manner. In other words, the NTN device (for example, a non-terrestrial network device) such as a satellite (SAT) and an unmanned aircraft system platform (UAS platform) may communicate with the terminal device.

For terrestrial network communication, a communications device adaptable to land communication is not adaptable to a scenario such as a sea, a mountain, or a desert. Alternatively, considering construction and operation costs of the communications device, land communication generally does not cover a sparsely populated area. The NTN has many advantages over terrestrial network communication. First, the NTN communications network is not limited by a region. In theory, a satellite may orbit the Earth, so that every position in the Earth can be covered by satellite communication. In addition, a region that can be covered by the non-terrestrial network device is far greater than a region covered by a terrestrial communications device. In other words, an NTN cell can cover a larger range.

The non-terrestrial network device may move relative to the Earth. Therefore, in the NTN, the cell may move on the Earth's surface. In this case, it may be difficult for the network device to reliably determine a location of the terminal device, or even determine a country to which the terminal device belongs, resulting in that the NTN is difficult to support a regulatory service. On this basis, it is unreliable to rely only on a global navigation satellite system (GNSS) report from a terminal device. Reliability can be improved by using a solution of combining the GNSS report and a network-based solution. Therefore, the network operator should cross-check the location of the terminal device based on the GNSS location, reported by the terminal, obtained through satellite navigation positioning, thereby satisfying potential regulatory requirements.

### Positioning technology

As the communications technologies become more mature, some communications systems (for example, a 5G system) may adopt more communication algorithms. These communication algorithms may include high-rate information transmission, a positioning technology, and the like. For example, for the foregoing NTN system, not only the terminal device can be positioned by using the GNSS, but also the terminal device can be positioned by using a non-terrestrial communications device such as a satellite by using a communication algorithm, to satisfy a requirement of the NTN system.

Some wireless communications systems may include a server. Location coordinates of the terminal device may be calculated in the server. Such a server may also be referred to as a positioning server.

The positioning server may be a network device, provided by the operator, with a positioning function. The network device with the positioning function may be a core network device or a cloud server. For example, the positioning server in this embodiment of the present application may include one or more of a location management function (LMF), a location management component (LMC), or a local location management function (LLMF) located in a network device. This is not limited in this embodiment of the present application.

The positioning system may determine a location of a to-be-positioned object (hereinafter referred to as a target) by using a geometric positioning method. The geometric positioning may determine the location of the target based on a distance between the target and a reference point. The distance may be determined by a propagation time of a wireless signal or an angle between the target and the reference point. For example, the positioning system may calculate the location of the target by using a triangle method (or referred to as triangulation) or a polygon method (or referred to as multilateration). The triangulation usually needs to be implemented by obtaining an angle between a target and at least two reference points.

A geometrical principle of the geometric positioning may relate to basic concepts of triangulation and multilateration. The triangulation is a method of determining a location by measuring a side and an angle of a triangle. In positioning, it is common to perform measurement by using angle and side length information of a triangle. The multilateration is a method of determining a location through measurement of internal and external angles of a polygon. In the multilateration method, at least three reference points with known locations are needed to calculate a location of a target by measuring an angle between the target and these reference points. For example, trilateration is a method of calculating a location of a target based on three reference points with known locations by measuring a side length between the target and these reference points. This method is common in wireless positioning and indoor positioning systems.

According to the geometric positioning principle, a user can be positioned by measuring signals of different transmitters. Locations of different transmitters are locations of reference points. Alternatively, a user can be positioned by using a plurality of signals transmitted by the same transmitter. The transmitter may transmit signals at a plurality of different locations. The plurality of different locations may be locations of reference points. For example, based on a signal transmitted by the transmitter at a specific location, a distance between the user and the location may be determined; and based on a signal transmitted by the transmitter at another location, a distance between the user and the another location may be determined. The location of the user can be determined based on distances between the user and a plurality of locations.

### Antenna Array (Antenna Array)

The antenna array performs signal transmission or reception by using a plurality of antennas. By adjusting the antennas in the antenna array, the antenna array may be distributed in a specific geometric shape in space, such as a linear array, a uniform matrix, or a circular array. The antenna array may improve performance of a communications system by performing multi-path propagation processing and an anti-interference algorithm. In addition, the antenna array allows a plurality of independent signals to be transmitted simultaneously at the same frequency, thereby improving spectrum efficiency. A beamforming (beamforming) technology is used as an example. Based on the beamforming technology, the antenna array may form a beam in a specific direction by adjusting a phase and an amplitude of each antenna, thereby increasing sensitivity of a system in a specific direction and reducing interference to another direction. In radar and sensor applications, an antenna array can implement high-resolution target detection and tracking through beamforming.

A design of the antenna array may be adjusted according to a specific application requirement, thereby providing greater flexibility. In a communications system, an antenna array may be used in a multiple input multiple output (MIMO) system (also referred to as a multi-antenna system) to improve a data transmission rate and system reliability. In a radar system, an antenna array may be used to implement a phased array radar, with advantages such as fast scanning, target tracking, and anti-interference. In a wireless sensing network, an antenna array may be used for applications such as positioning, directional propagation, and energy focusing.

In general, the antenna array is a powerful technology and is widely applied in wireless communication, radars, sensing, and other wireless application fields.

### Phase Estimation

During positioning, a more accurate distance between a signal transmitting party and a signal receiving party can be obtained by measuring phase information of a received signal. The phase information may be obtained through phase estimation. Due to various reasons, a phase of a signal may be affected by noise, resulting in uncertainty of phase estimation.

For the NTN system, phase estimation of a signal transmitted by an NTN device may be affected by one or more of the following: a propagation environment, a receiving system, the NTN device itself, or the like. The following is described by using an example in which the NTN device is a satellite.

A propagation environment of a satellite signal includes the atmosphere on the Earth's surface. The ionosphere and the troposphere in the atmosphere may cause variations in refraction and a propagation speed of an electromagnetic wave, thereby affecting a phase of a signal. The atmospheric impact is commonly referred to as an atmospheric delay. The atmospheric delay is an important source of error in phase estimation for some navigation systems (for example, a global positioning system (global positioning system, GPS) or a BeiDou system).

Multipath effect may indicate that a signal passes through different paths to arrive at a signal receiving device (or referred to as a receiving station, a receiving party, a receiver, or a receive end), resulting in simultaneous arrival of a plurality of versions of the signal, thus generating phase distortion. The multipath effect affects the phase estimation.

An internal clock error of the receive end also affects the phase estimation. Even if a clock at the receive end is very accurate, a clock difference may still exist for various reasons (such as temperature change and clock drift).

A delay introduced by hardware (an antenna, an amplifier, a mixer, a transmissions line, and the like) in a satellite system affects phase estimation of a signal.

Motion of the satellite may lead to the Doppler effect, which may result in signal frequency change, thus affecting accuracy of the phase estimation.

Calibration accuracy of the signal receiving device directly affects the accuracy of the phase estimation. Calibration quality of each component in the signal receiving device affects the phase of the signal.

The foregoing factors may lead to a phase estimation error. Therefore, in applications such as satellite communication and navigation, a series of technical solutions are usually used to reduce these errors, such as a differential technology and beamforming.

The differential technology is a method used for reducing or eliminating common errors such as an atmospheric delay, and is widely used especially in a satellite navigation system and other applications requiring high-precision phase measurement.

A phase differential technology may include single-point phase differentiation and dual-point phase differentiation.

The single-point phase differentiation may eliminate some errors between two receiving stations (reference and primary receivers) by using a reference receiver within a receiving station. The reference receiver is usually considered to be free from errors such as an atmospheric delay. Therefore, observations of the reference receiver can be used to calibrate observations of the primary receiver. By performing differential operation on observation data of the primary receiver and observation data of the reference receiver, some common errors such as an atmospheric delay and a receiver clock difference can be eliminated. The single-point phase differentiation is usually applicable to applications within a relatively short distance range.

The dual-point differentiation takes a difference between two receiving stations into account, so that a difference in space may also be used to calibrate an error such as an atmospheric delay. The dual-point differentiation is usually applied to two receiving stations being distant from each other. The dual-point differentiation takes spatial change into account in addition to single-point calibration, thereby implementing higher accuracy.

By using the differential technology, an error such as an atmospheric delay can be eliminated to some extent, thereby improving precision of phase measurement. The phase estimation based on differential technology can be applied to fields such as satellite navigation, Earth observation, and scientific research with high precision.

It can be learned from the differential technology that the receive end may perform phase estimation on signals from different satellites, and perform subtraction on estimated phases, to eliminate a clock difference at the receive end, a phase error caused by hardware at the receive end, an atmospheric error, and the like. However, most errors are eliminated for the receive end, and impact of a satellite clock difference, a satellite initial phase, and a satellite hardware delay on phase measurement cannot be eliminated.

Therefore, it is difficult to eliminate impact of the transmit end on the phase measurement by using a related technology. For example, in a related technology, it is difficult to eliminate impact of factors such as a clock difference, a hardware delay, and an initial phase of the transmit end on the phase measurement. Therefore, it is difficult to obtain an accurate phase measurement result.

FIG. 2 is a schematic flowchart of a wireless communication method according to an embodiment of the present application, to resolve the foregoing problems.

The method shown in FIG. 2 may be executed by a first terminal device and a first device. The first device may be a mobile device. For example, the first device may include an NTN device. For example, the first device may include a satellite. It should be noted that the mobile device may be a device that moves relative to the ground or the Earth.

The method shown in FIG. 2 may include step S210.

In step S210, the first device transmits a first signal and a second signal to the first terminal device.

A location at which the first device transmits the first signal may be a first location, and a location at which the first device transmits the second signal may be a second location. The first location and the second location may be different. In other words, the first signal and the second signal may be signals transmitted at different locations by a same transmit end. For signals transmitted at different locations, a receive end performs detection on the received signals to obtain more spatial information. In other words, signals transmitted at different locations carry more spatial information.

It should be noted that that the first location and the second location are different may indicate that the first location and the second location are different with reference to the ground or the Earth. In other words, the first device may be a device that moves relative to the ground.

In some embodiments, a transmitting instant of the first signal is a first instant, and a transmitting instant of the second signal is a second instant. The first instant is different from the second instant. In other words, the transmitting instant of the first signal is different from the transmitting instant of the second signal. The first device may be movable. Therefore, in a case that the transmitting instant of the first signal is different from the transmitting instant of the second signal, locations at which the first device transmits the first signal and the second signal may also be different.

It should be noted that a sequence of transmitting the first signal and the second signal is not limited in the present application. For example, the first signal may be transmitted earlier or later than the second signal. In other words, the first instant may be earlier than the second instant, or may be later than the second instant.

At least one of the first signal or the second signal may be a signal that can be used for phase estimation. For example, at least one of the first signal or the second signal may include a signal used for positioning. The signal used for positioning may be, for example, a positioning reference signal (positioning reference signal, PRS). For example, the first signal may include a first PRS. For another example, the second signal may include a second PRS. The signal used for positioning may be, for example, a sounding reference signal (sounding reference signal, SRS). For example, the first signal may include a first SRS. For another example, the second signal may include a second SRS.

In some embodiments, the first device may transmit a plurality of signals, and the plurality of signals may include the first signal and the second signal. For example, the first signal and the second signal may be two adjacent signals in the plurality of signals. Alternatively, the first signal and the second signal may be spaced by at least one signal. The plurality of signals may be periodically transmitted. To be specific, transmission intervals between any two adjacent signals in the plurality of signals may be equal. The plurality of signals may alternatively be aperiodically transmitted.

The first signal and the second signal may be used for determining first phase information. The first phase information may include a receive phase difference between the first signal and the second signal on a side of the first terminal device.

For example, the first terminal device may perform detection on the first signal and the second signal, to perform phase estimation on the first signal and the second signal. For example, the first terminal device may determine phase information based on a time at which at least one of the first signal or the second signal arrives at the first terminal device. For example, through detecting the first signal, the first terminal device may obtain phase information of the first signal. Through detecting the second signal, the first terminal device may obtain phase information of the second signal. The phase information may include a detected phase. The receive phase difference may be obtained through performing difference calculation on a phase of the first signal and a phase of the second signal.

It should be noted that the process of performing difference calculation on the phase of the first signal and the phase of the second signal may include: subtracting the phase of the second signal from the phase of the first signal; or subtracting the phase of the first signal from the phase of the second signal.

It can be learned that the receive phase difference is a phase difference obtained based on the phase of the first signal and the phase of the second signal that are detected by the first terminal device side. Correspondingly, at the transmit end, a difference between a transmit phase of the first signal and a transmit phase of the second signal may be referred to as a transmit phase difference.

It should be noted that the phase of the first signal or the second signal may be used as a reference phase, to calculate the receive phase difference. In other words, for any one of a plurality of signals received by the first terminal device, a receive phase difference between a phase of the signal and a reference phase may be calculated based on the reference phase. The reference phase or a signal corresponding to the reference phase may be determined by the first terminal device, or may be indicated by a network device.

It may be understood that the first phase information proposed in the present application may include the receive phase difference between the plurality of signals transmitted by the same transmit end at different locations. Because the transmit end is the same device, the receive phase difference obtained based on the present application is not affected by a delay of the transmit end, thereby implementing accurate measurement. The following analyzes and describes a hardware delay error of the transmit end in the present application by using an example in which the first device includes a satellite.

Hardware of different satellites is different. Therefore, hardware delay errors of different satellites are different. If the hardware delay error is not accurately compensated or corrected, a calculated phase difference contains a corresponding error, thus affecting accuracy of a measurement result. In a related technology, to minimize impact of the hardware delay error, measures such as precise clock synchronization may be used. However, it is difficult for clocks of different satellites to be completely consistent. Therefore, some residual hardware delay errors may still exist.

For the same satellite, a hardware delay is usually relatively constant because the hardware delay is mainly caused by a signal propagation time and a signal processing time. These factors are unlikely to significantly change in a short time. The following is described by using a hardware delay such as a transmission delay, a signal processing delay, or a storage delay as an example. The transmission delay may indicate a time required for a signal to be transmitted from a ground station to a satellite and then returned to the ground station. The transmission delay depends mainly on a signal propagation speed, that is, a propagation speed of an electromagnetic wave in space. Because the light speed is a constant and does not change with time, the transmission delay is relatively stable. The signal processing delay may indicate a time required for signal processing performed by a satellite. The signal processing may include decoding, processing sensor data, executing instructions, and the like. It may be understood that the signal processing delay is usually relatively constant, and changes only when hardware or software on the satellite is upgraded or changed. The storage delay may indicate a time required for storing a signal in a storage device if there is the storage device on the satellite. The storage delay is also usually relatively stable unless a storage medium or a storage system changes.

For a same device, some delays that affect phase estimation on the transmit end are relatively constant, for example, a hardware delay. Therefore, it may be considered that these delays of the first device substantially maintain unchanged at an instant of transmitting the first signal and an instant of transmitting the second signal. When the receive phase difference between the first signal and the second signal is calculated, a part of the receive phase difference affected by these delays of the transmit end may be eliminated through difference calculation, so that the receive phase difference is not affected by the delays such as a hardware delay of the transmit end.

In particular, in a complex environment, an error caused by the hardware delay is more apparent. Therefore, in the present application, accurate modeling and correction can be performed on the hardware delay error, to implement high-precision measurement. A relatively accurate measurement result can be obtained in the complex environment. In other words, the present application may be further applied to a high-precision measurement application.

In addition, based on the present application, the first device may construct an equivalent antenna array through motion. That is, the first signal and the second signal may be signals transmitted by different antennas in the equivalent antenna array. In other words, the same antenna transmits signals at different locations, to implement coordination of the same antenna at different locations, thereby forming the equivalent antenna array. A technical solution (for example, beamforming) implemented based on the antenna array may be used by constructing the equivalent antenna array, thereby improving performance of a communications system.

For constructing an array antenna, the signals transmitted by the transmit end at different locations need to be correlated with each other. The following is described from the perspective of the receive end. A signal received by the receive end may be expressed by y(t)=h(t)*s(t)+n(t), where y(t) may represent a received signal, h(t) may represent a channel impulse response, s(t) represents a transmitted signal, and n(t) represents noise. The channel propagation delay may be reflected in the channel impulse response. The receive end may perform phase estimation on the received signal y(t). It can be learned from the foregoing formula that a phase of y(t) is estimated with reference to both the channel propagation delay and the transmitted signal s(t). The receive phase difference between the transmitted first signal s(t1) and the transmitted second signal s(t2) may be calculated in the following two manners. In a first manner, if transmitted signals of the first signal and the second signal are the same, the transmitted signal may be eliminated when the receive phase difference between the first signal and the second signal is calculated. In a second manner, if the transmitted signals of the first signal and the second signal are different, the receive phase difference between the first signal and the second signal is calculated. The difference includes phase difference information of the transmitted signals s(t1) and s(t2). In this case, the receive phase difference cannot accurately reflect a propagation delay. Therefore, when transmitting the first signal and the second signal, the transmit end needs to coordinate signal phases of the first signal and the second signal.

A relationship between the phase of the first signal and the phase of the second signal on the first device side may be a first relationship. In other words, the relationship between the phase of the first signal when the first signal is transmitted and the phase of the second signal when the second signal is transmitted may be the first relationship. In other words, a relationship between the phase of the first signal in a transmit antenna and the phase of the second signal in the transmit antenna may be the first relationship. In other words, a relationship between the phase of the first signal transmitted by a transmit antenna and the phase of the second signal transmitted by the transmit antenna may be the first relationship. Alternatively, a relationship between a transmit phase of the first signal and a transmit phase of the second signal may be the first relationship.

The receive phase difference may be related to the first relationship. The receive phase difference can be more accurately determined based on the first relationship. The following describes the first relationship.

In some embodiments, the first device may transmit assistance information to the first terminal device. The assistance information may be used to indicate the first relationship. For example, the first device may obtain a condition of the first relationship on the local side. Based on the obtained first relationship, the first device may indicate the first relationship to the first terminal device by using the assistance information.

Optionally, the assistance information may be carried in higher layer signaling. For example, the assistance information may be carried in one or more of the following messages: an RRC message, or a MAC CE.

In some embodiments, the first relationship may include one or more of the following: the transmit phase difference between the first signal and the second signal on the first device side; or an equivalent time difference corresponding to the transmit phase difference.

A difference between a transmit phase of the first signal and a transmit phase of the second signal may be the transmit phase difference. When transmitting the first signal and the second signal, the first device may obtain the transmit phase of the first signal and the transmit phase of the second signal, and determine the transmit phase difference. In some embodiments, the first device may directly indicate the transmit phase difference to the first terminal device by using the assistance information.

In some embodiments, the transmit phase difference may correspond to the equivalent time difference. The first device may indicate the equivalent time difference to the first terminal device by using the assistance information. The first terminal device may determine the transmit phase difference based on the equivalent time difference.

Optionally, the transmit phase difference and the equivalent time difference may satisfy: Transmit phase difference=mod(2πf*Equivalent time difference, 2π). In which, f may represent a carrier frequency of the first signal or the second signal, and mod( ) may represent a modulo operation.

It may be understood that the first device may indicate the first relationship by using the assistance information. For example, on a side of the first device that transmits the first signal and the second signal, the phase of the first signal and the phase of the second signal may be not limited. The first device may measure the transmit phase of the first signal and the transmit phase of the second signal, and determine the first relationship. The first device may notify the first terminal device of the determined first relationship by using the assistance information, so that the first terminal device adjusts the receive phase difference based on the first relationship indicated by the assistance information. Therefore, a signal can be flexibly transmitted by the first device by using an indication of the assistance information, thereby simplifying a signal processing process of the first device.

It should be noted that, corresponding assistance information may be transmitted for any two signals among a plurality of signals, so that a phase relationship between the plurality of signals at the transmit end can be dynamically indicated.

In some embodiments, the first relationship may be configured by the network device. The network device may include one or more of the following: the first device, a serving base station, a neighboring cell base station, a positioning server, or the like. In a case that the network device configures the first relationship for the first terminal device, the first terminal device may determine the receive phase difference based on the first relationship. In a case that the network device does not include the first device, the network device may configure the first relationship for the first device. The first device may transmit the first signal and the second signal based on the first relationship. In other words, the first device and the first terminal device may agree on the first relationship, to implement accurate communication or positioning.

In some embodiments, the first relationship may be defined by a protocol. The first device may transmit the first signal and the second signal based on the first relationship defined in the protocol. The first terminal device may determine the receive phase difference based on the first relationship defined in the protocol.

In some embodiments, the first relationship may include that the phase of the first signal and the phase of the second signal are the same on the first device side.

In a case that the phase of the first signal and the phase of the second signal are the same on the first device side, the first terminal device may directly obtain the receive phase difference based on the detected phases. In other words, the first terminal device may not adjust the receive phase difference, thereby simplifying processing performed on the first terminal device side.

A signal (including the first signal or the second signal) received by the first terminal device may satisfy: y(t)=h(t)*s(t)+n(t). In which, y(t) may represent a received signal, h(t) may represent a channel impulse response, s(t) may represent a transmitted signal, and n(t) may represent noise. The channel propagation delay may be reflected in the channel impulse response.

Therefore, in a case that the first terminal device performs phase estimation on the received signal y(t), the phase information obtained through the phase estimation may include the propagation delay and a phase difference of the signal. A phase difference is calculated for received signals of the first signal and the second signal in the following two manners. In a first manner, if the transmit phase of the first signal and the transmit phase of the second signal are the same, the transmitted signal may be eliminated when the receive phase difference between the first signal and the second signal is calculated, thereby eliminating a constant delay of the transmit end. In a second manner, if the transmit phase of the first signal and the transmit phase of the second signal are different, a phase difference between the first signal and the second signal is calculated. The difference includes phase information of a transmitted signal. The difference cannot accurately reflect the propagation delay.

In some embodiments, the first relationship may include that the phase of the first signal and the phase of the second signal are continuous in time or phase on the first device side. Based on time continuity or phase continuity, the first terminal device may adjust the receive phase difference, so that the receive phase difference accurately reflects the propagation delay.

Optionally, the phase of the first signal and the phase of the second signal are continuous in time on the first device side, when a following condition is satisfied: Ø₂=mod(Ø₁+2πfΔt, 2π). In which, Ø₁ represents the phase of the first signal on the first device side, Ø₂ represents the phase of the second signal on the first device side, f represents a carrier frequency of the first signal or the second signal, and Δt represents a time interval between the first signal and the second signal. The time interval may indicate a time difference between an instant at which the first signal is transmitted and an instant at which the second signal is transmitted.

In some embodiments, when the phase of the first signal and the phase of the second signal are different on the first device side, the receive phase difference may be adjusted to accurately reflect the propagation delay. For example, the receive phase difference may satisfy: ΔØ=Ø₁−Ø₂+mod(2πfΔt, 2π); or ΔØ=Ø₂−Ø₁−mod(2πfΔt, 2π), where AØ represents the receive phase difference, Ø₁ represents the phase of the first signal on the first device side, Ø₂ represents the phase of the second signal on the first device side, f represents the carrier frequency of the first signal or the second signal, and Δt represents the time interval between the first signal and the second signal. For example, when the phase difference is obtained by subtracting the phase of the second signal from the phase of the first signal, the receive phase difference may satisfy: ΔØ=Ø₁−Ø₂+mod(2πfΔt, 2π); or when the phase difference is obtained by subtracting the phase of the first signal from the phase of the second signal, ΔØ=Ø₂−Ø₁−mod(2πfΔt, 2π).

In some embodiments, a location of the first terminal device may be calculated based on the first phase information.

In some embodiments, the first device may transmit capability information to the first terminal device. The capability information may be used to indicate whether the first terminal device supports calculation of the receive phase difference between the first signal and the second signal. In other words, the first terminal device may report whether the first terminal device supports difference calculation based on phase estimation on different signals of the same device.

Optionally, in a case that a moving speed of the first terminal device is less than or equal to a first speed threshold, the first terminal device may support calculation of the receive phase difference between the first signal and the second signal; and/or in a case that the moving speed of the first terminal device is greater than the first speed threshold, the first terminal device may not support calculation of the receive phase difference between the first signal and the second signal. The first speed threshold is a positive number. In other words, in a case that the first terminal device does not move at a high speed, the first terminal device can support calculation of the receive phase difference between the first signal and the second signal.

When the first terminal device moves at a high speed, and the first terminal device detects the first signal and the second signal, a location of a user changes greatly. In a case that the location changes greatly, a scattering environment around the first terminal device changes greatly. Therefore, a correlation between a phase of the received first signal and a phase of the received second signal is relatively low. Even if the receive phase difference is obtained, the receive phase difference cannot reflect a distance between the first terminal device and the first device, resulting in that the receive phase difference cannot be used for distance estimation and therefore cannot be used for location estimation of the first terminal device.

In some embodiments, the first terminal device may receive first information. The first information may be transmitted by the first device. The following describes the first information.

In some implementations, the first information may be used to configure the first signal and/or the second signal. In this case, the first information may be used to configure, for example, one or more of the following information: a transmitting instant of the first signal, a receiving instant of the first signal, a transmitting instant of the second signal, a receiving instant of the second signal, an identity of the first signal, or an identity of the second signal.

In a case that the first signal and the second signal are signals of the same type, for example, both the first signal and the second signal are PRS signals, the first information may be used to configure a transmitting instant and/or a receiving instant of a signal of this type. For example, the first information may be used to configure transmitting instants and/or receiving instants of a plurality of PRS signals.

In some embodiments, the receiving instant may also be referred to as a detection time stamp (time stamp). In other words, the receiving instant of the first signal may be referred to as a detection time stamp of the first signal, and the receiving instant of the second signal may be referred to as a detection time stamp of the second signal.

As described above, the first signal and the second signal may belong to a plurality of periodically transmitted signals. In this case, the first information may indicate a transmitting period of the plurality of signals. For example, the transmitting period may include a transmitting interval and/or a transmitting offset.

The first terminal device may receive and detect the first signal and/or the second signal based on the first information. In other words, based on the first information, the first terminal device may perform step S210.

It should be noted that the transmitting instant or the receiving instant in the present application may be represented by using one or more of the following: absolute time or a first time unit. The absolute time may be, for example, world time. For example, the first information may indicate that the transmitting instant of the first signal is 14:01:23.000001 on Dec. 19, 2023. The absolute time may be in a form of a time stamp (time stamp). The first time unit in the first information may include one or more of the following: a frame, a subframe, or an orthogonal frequency division multiplexing (orthogonal frequency division multiplexing, OFDM) symbol. For example, the first information may indicate one or more of a frame number, a subframe number, or an OFDM symbol index of the transmitting instant of the second signal.

In some implementations, the first information may indicate whether the first terminal device needs to calculate the receive phase difference between the first signal and the second signal.

In some implementations, the first information may indicate whether difference calculation based on phase estimation is enabled for the plurality of signals transmitted by the first device. For example, the plurality of signals may be signals used for positioning, and the first information may indicate whether the signal that is used for positioning and that is transmitted by the first device supports difference calculation based on phase estimation.

In some implementations, the first information may indicate whether difference calculation based on phase estimation is enabled for the first signal and the second signal.

In some embodiments, the first terminal device may determine the first phase information. In some embodiments, the first terminal device may transmit the phase information of the first signal and the phase information of the second signal to another device (for example, the second device described below), so that the another device determines the first phase information.

The receive phase difference between the first signal and the second signal may be used to position the first terminal device. In a case that the first terminal device determines the first phase information, the first terminal device may determine the location of the first terminal device based on the first phase information. In a case that the first terminal device transmits the first phase information to the another device, the another device (for example, the second device described below) may calculate the location of the first terminal device.

In some embodiments, the method shown in FIG. 2 may further include step S220. Step S220 may be performed by the first terminal device and the second device.

In step S220, the first terminal device transmits one or more of the first phase information, the phase information of the first signal, or the phase information of the second signal, to the second device.

In some embodiments, the second device may include a destination party, that is, a final signal receiver. In some embodiments, the second device may include a forwarding device (or a relay device). For example, the second device may forward the received first phase information to the another device.

The second device may include one or more of the following: a location calculation unit, a positioning server, a second terminal device functioning as a central node, or a first base station.

The location calculation unit may participate in calculation of the location of the first terminal device. An output of the location calculation unit may include one or more of the following: the location of the first terminal device, or intermediate data for calculating the location of the first terminal device. The intermediate data may include a distance, an angle, and the like between the first terminal device and the first device. The location calculation unit may be any device that participates in positioning of the first terminal device. For example, the location calculation unit may be one or more of the following devices: the first terminal device, the first device, the second device, the positioning server, a base station, a core network device, or the second terminal device.

In a case that the second device includes the location calculation unit, the location calculation unit may determine the first phase information based on the phase information of the first signal and the phase information of the second signal, and/or the location calculation unit may calculate the location of the first terminal device based on the first phase information.

In a case that the second device includes the positioning server, the positioning server may determine the first phase information based on the phase information of the first signal and the phase information of the second signal, and/or the positioning server may calculate the location of the first terminal device based on the first phase information.

In a case that the second device includes the second terminal device functioning as the central node, the second terminal device may determine the first phase information based on the phase information of the first signal and the phase information of the second signal, and/or the second terminal device may calculate the location of the first terminal device based on the first phase information.

In a case that the second device includes the first base station, the first base station may determine the first phase information based on the phase information of the first signal and the phase information of the second signal, and/or the first base station may calculate the location of the first terminal device based on the first phase information.

The first base station may include a serving base station and/or a neighboring cell base station (or a neighboring transmitting point) of the first terminal device. In other words, the first terminal device may communicate with the serving base station and/or the neighboring cell base station. For example, in a case that the first terminal device is located within coverage of a serving base station, the second device may include the serving base station. In a case that the first terminal device moves out of the coverage of the serving base station, the second device may include a neighboring cell base station. For example, in a case that the first terminal device is in a radio resource control (radio resource control, RRC) inactive state or an RRC idle state, the first terminal device may move out of the coverage of the serving base station.

Optionally, in a case that the second device includes the neighboring cell base station, the first terminal device may transmit a signal (for example, the first phase information) by using an uplink grant (UL grant) allocated by the serving base station.

The uplink grant allocated by the serving base station may be indicated by using second information. In other words, the serving base station may transmit the second information to the neighboring cell base station. The second information may be used to indicate a detection-related parameter such as time-frequency code of an uplink grant. For example, the serving base station may transmit the second information to all neighboring cell base stations that can detect the uplink grant.

Optionally, in a case that the second device includes the neighboring cell base station, the first terminal device may transmit a signal (for example, the first phase information) to the neighboring cell base station by using a first resource. The first resource may be a resource shared by the serving base station and the neighboring cell base station.

The neighboring cell base station and the serving base station may belong to a plurality of base stations. Resources shared by the plurality of base stations may form a shared resource pool. The first resource may be obtained from the shared resource pool. For example, the first resource may be obtained from the shared resource pool in a scheduling-free manner.

As described above, the first phase information may be used to calculate the location of the first terminal device. In other words, the location of the first terminal device may be calculated based on receive phase differences between the plurality of signals transmitted by the first device. Location calculation may be implemented through geometric positioning.

In a related technology, if the first device moves, a specific error may exist in the location of the first terminal device determined based on the signals transmitted by the first device. For example, the first device includes a satellite. To determine the location of the first terminal device, a location of the satellite needs to be determined. In a related technology, a transmitting instant of the satellite may be determined based on a time instant at which a positioning signal is received and an approximate distance between the first terminal device and the satellite, to determine the location of the satellite. However, because a moving speed of the satellite is relatively high, an error exists in the transmitting instant of the satellite determined based on an approximate distance between a terminal device and the satellite. In this case, a deviation may occur in location estimation of the satellite, resulting in an error in positioning of the first terminal device. In the present application, the location of the satellite is determined with reference to the receive phase difference, and a corresponding time difference is determined based on the receive phase difference, to determine a moving distance of the satellite. Further, the first terminal device is more accurately positioned with reference to the moving distance of the satellite.

Optionally, the location of the first terminal device may be determined based on one or more of the following information: the first phase information, information about the first device, information about the first terminal device, the first location, the second location, or the like.

The information about the first device may include one or more of the following: a running trajectory of the first device, ephemeris information of the first device, the instant at which the first device transmits the first signal, the instant at which the first device transmits the second signal, or an identity of the first device. The running trajectory may include an actual running trajectory and/or an equivalent running trajectory.

The information about the first terminal device may include one or more of the following: an instant at which the first terminal device receives the first signal or an instant at which the first terminal device receives the second signal. An instant at which a signal is received may be represented by using a time stamp.

It should be noted that when the second device calculates the location of the first terminal device, and if a module used for location calculation is not included in the first device (that is, the first device and the second device belong to different devices), at least one of the first device or the first terminal device needs to transmit the information about the first device to the second device.

In some embodiments, the first phase information may be used to calculate the first location and the second location. The first location and the second location may be calculated based on one or more of the following: the first information, the information about the first device, third information, the information about the first terminal device, or clock-related information.

The third information may be used to indicate a correspondence between the first phase information and the location (including the first location and the second location) of the first device. For example, the third information may be used to indicate one or more of the following: a relationship between the first phase information and the first signal, a relationship between the first phase information and the second signal, or a relationship between the first phase information and the first device. The relationship between the first phase information and the first signal may be indicated by using an identity (ID) of the first signal. Similarly, the relationship between the first phase information and the second signal may be indicated by using an ID of the second signal. In other words, the third information may indicate that the first phase information is determined based on signals with two specific IDs. Therefore, the first location can be determined based on the identity of the first signal, and the second location can be determined based on the identity of the second signal. For example, both the first signal and the second signal are PRSs, and PRSs transmitted at different instants may have different PRS IDs. The relationship between the first phase information and the first device may be indicated by using the ID of the first device. For example, in a case that the first device is a satellite, the correspondence may be determined based on an ID of the satellite. In other words, the third information may indicate that the first phase information is determined based on information transmitted by a device with a specific ID.

It may be understood that the location of the first terminal device can be calculated based on the correspondence indicated by the third information.

By using an example in which both the first signal and the second signal are PRSs, the following describes determining of the first location and the second location. The first terminal device may report a PRS ID corresponding to the first phase information. Based on the PRS ID, the second device may determine a location (including the first location and/or the second location) at which the first device transmits a PRS.

The following describes an example in which the first signal is a first PRS, the second signal is a second PRS, and the first device is a satellite. Steps 1 to 3 are used as an example to describe a method for determining the first location and the second location. Step 1: a receiving instant of the first PRS is determined based on a configuration ID of the first PRS, and a receiving instant of the second PRS is determined based on a configuration ID of the second PRS. Step 2: approximate transmitting instants of the first PRS and the second PRS are determined based on the receiving instant of the first PRS, the receiving instant of the second PRS, and an approximate distance between the first terminal device and the satellite. Step 3: the first location is determined based on the transmitting instant of the first PRS with reference to the ephemeris information, and the second location is determined based on the transmitting instant of the second PRS with reference to the ephemeris information.

The clock-related information may also be referred to as information related to a detection time stamp. The clock-related information may include information related to a time difference between a clock of the first terminal device and a reference clock.

The first terminal device may report one or more pieces of the foregoing information to the second device, so that the second device calculates one or more of the information about the first terminal device, the first location, or the second location. For example, the first terminal device transmits the third information to the second device. By using an example in which the first device is a satellite and both the first signal and the second signal are PRSs, the following describes information reported by the first terminal device to the second device.

For example, the first terminal device may report the detected phase information, the satellite ID corresponding to the phase information, and the first information.

For another example, the first terminal device may report the detected phase information, the satellite ID corresponding to the phase information, and a PRS detection time stamp. The PRS detection time stamp may be used to determine a location at which the satellite transmits the PRS.

For another example, the first terminal device may report the detected phase information, the satellite ID corresponding to the phase information, a PRS detection time stamp, and information related to a detection time stamp.

For another example, the first terminal device may report a phase difference between the first signal and the second signal.

In some embodiments, a transmission interval between the first signal and the second signal may be greater than a threshold. The threshold may be related to one or more of the following: a transmission delay between the first terminal device and the first device, or a processing delay of the first terminal device.

In a case that the first signal and the second signal are a plurality of periodically transmitted signals, a transmission interval (briefly referred to as a period interval) between any two adjacent signals in the plurality of signals may be greater than the threshold.

It may be understood that, for the plurality of periodically transmitted signals, when the period interval is greater than the threshold, at least one of the first location or the second location of the first device may be determined based on an aperiodic condition.

The foregoing describes the method embodiments of the present application in detail. The following describes apparatus embodiments of the present application in detail. It should be understood that the description of the method embodiments corresponds to the description of the apparatus embodiments, and therefore, for a part that is not described in detail, reference may be made to the foregoing method embodiments.

FIG. 3 is a schematic structural diagram of a communications device 300 according to an embodiment of the present application. The communications device 300 is a first device. The communications device 300 includes a first transmitting unit 310.

The first transmitting unit 310 is configured to transmit a first signal and a second signal to a first terminal device, where a relationship between a phase of the first signal and a phase of the second signal on a side of the first device is a first relationship, the first signal and the second signal are used for determining first phase information, the first phase information includes a receive phase difference between the first signal and the second signal on a side of the first terminal device, a location at which the first device transmits the first signal is a first location, a location at which the first device transmits the second signal is a second location, and the first location and the second location are different.

In some embodiments, the communications device 300 is further configured to transmit assistance information to the first terminal device, where the assistance information is used to indicate the first relationship.

In some embodiments, the assistance information is carried in higher layer signaling.

In some embodiments, the first relationship includes one or more of the following: a transmit phase difference between the first signal and the second signal on the first device side; or an equivalent time difference corresponding to the transmit phase difference.

In some embodiments, the transmit phase difference and the equivalent time difference satisfy: Transmit phase difference=mod(2πf*Equivalent time difference, 2π), where f represents a carrier frequency of the first signal or the second signal, and mod ( ) represents a modulo operation.

In some embodiments, the first relationship is configured by a network device or defined by a protocol.

In some embodiments, the first relationship includes that the phase of the first signal and the phase of the second signal are the same on the first device side.

In some embodiments, the first relationship includes that the phase of the first signal and the phase of the second signal are continuous in time on the first device side.

In some embodiments, the phase of the first signal and the phase of the second signal being continuous in time includes that the phase of the first signal and the phase of the second signal on the first device side satisfy: Ø₂=mod(Ø₁+2πfΔt, 2π) , where Ø₁ represents the phase of the first signal on the first device side, Ø₂ represents the phase of the second signal on the first device side, f represents a carrier frequency of the first signal or the second signal, Δt represents a time interval between the first signal and the second signal, and mod ( ) represents a modulo operation.

In some embodiments, the communications device 300 is further configured to transmit first information to the first terminal device, where the first information is used for executing one or more of the following: configuring the first signal and the second signal; indicating whether the first terminal device needs to calculate the receive phase difference; indicating whether difference calculation based on phase estimation is enabled for a plurality of signals transmitted by the first device; or indicating whether difference calculation based on phase estimation is enabled for the first signal and the second signal.

In some embodiments, the first information is used for configuring one or more of the following: a transmitting instant of the first signal; a receiving instant of the first signal; a transmitting instant of the second signal; or a receiving instant of the second signal.

In some embodiments, the first signal includes a first positioning reference signal PRS; and/or the second signal includes a second PRS.

In some embodiments, the first device includes an NTN device.

In some embodiments, the receive phase difference satisfies: ΔØ=Ø₁−Ø₂+mod(2πfΔt, 2π); or ΔØ=Ø₂−Ø₁−mod(2πfΔt, 2π), where ΔØ represents the receive phase difference, Ø₁ represents the phase of the first signal on the first device side, Ø₂ represents the phase of the second signal on the first device side, f represents a carrier frequency of the first signal or the second signal, Δt represents a time interval between the first signal and the second signal, and mod ( ) represents a modulo operation.

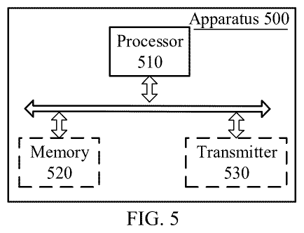

In an optional embodiment, the first transmitting unit 310 may be a transceiver 530. The communications device 300 may further include a processor 510 and a memory 520, which are specifically shown in FIG. 5.

FIG. 4 is a schematic structural diagram of a terminal device 400 according to an embodiment of the present application. The terminal device 400 is a first terminal device. The terminal device 400 includes a first receiving unit 410.

The first receiving unit 410 is configured to receive a first signal and a second signal that are transmitted by a first device, where a relationship between a phase of the first signal and a phase of the second signal on a side of the first device is a first relationship, the first signal and the second signal are used for determining first phase information, the first phase information includes a receive phase difference between the first signal and the second signal on a side of the first terminal device, a location at which the first device transmits the first signal is a first location, a location at which the first device transmits the second signal is a second location, and the first location and the second location are different.

In some embodiments, the terminal device 400 is further configured to receive assistance information transmitted by the first device, where the assistance information is used to indicate the first relationship.

In some embodiments, the assistance information is carried in higher layer signaling.

In some embodiments, the first relationship includes one or more of the following: a transmit phase difference between the first signal and the second signal on the first device side; or an equivalent time difference corresponding to the transmit phase difference.

In some embodiments, the transmit phase difference and the equivalent time difference satisfy: Transmit phase difference=mod(2πf*Equivalent time difference, 2π), where f represents a carrier frequency of the first signal or the second signal, and mod ( ) represents a modulo operation.

In some embodiments, the first relationship is configured by a network device or defined by a protocol.

In some embodiments, the first relationship includes that the phase of the first signal and the phase of the second signal are the same on the first device side.

In some embodiments, the first relationship includes that the phase of the first signal and the phase of the second signal are continuous in time on the first device side.

In some embodiments, the phase of the first signal and the phase of the second signal being continuous in time includes that the phase of the first signal and the phase of the second signal on the first device side satisfy: Ø₂=mod(Ø₁+2πfΔt, 2π), where Ø₁ represents the phase of the first signal on the first device side, Ø₂ represents the phase of the second signal on the first device side, f represents a carrier frequency of the first signal or the second signal, Δt represents a time interval between the first signal and the second signal, and mod ( ) represents a modulo operation.

In some embodiments, the terminal device 400 is further configured to receive first information transmitted by the first device, where the first information is used for executing one or more of the following: configuring the first signal and the second signal; indicating whether the first terminal device needs to calculate the receive phase difference; indicating whether difference calculation based on phase estimation is enabled for a plurality of signals transmitted by the first device; or indicating whether difference calculation based on phase estimation is enabled for the first signal and the second signal.

In some embodiments, the first information is used for configuring one or more of the following: a transmitting instant of the first signal; a receiving instant of the first signal; a transmitting instant of the second signal; or a receiving instant of the second signal.

In some embodiments, the first signal includes a first positioning reference signal PRS; and/or the second signal includes a second PRS.

In some embodiments, the first device includes an NTN device.

In some embodiments, the receive phase difference satisfies: ΔØ=Ø₁−Ø₂+mod(2πfΔt, 2π); or ΔØ=Ø₂−Ø₁−mod(2πfΔt, 2π), where ΔØ represents the receive phase difference, Ø₁ represents the phase of the first signal on the first device side, Ø₂ represents the phase of the second signal on the first device side, f represents a carrier frequency of the first signal or the second signal, Δt represents a time interval between the first signal and the second signal, and mod ( ) represents a modulo operation.

In an optional embodiment, the first receiving unit 410 may be a transceiver 530. The terminal device 400 may further include a processor 510 and a memory 520, which are specifically shown in FIG. 5.

FIG. 5 is a schematic structural diagram of an apparatus for communication according to an embodiment of the present application. Dashed lines in FIG. 5 indicate that a unit or module is optional. The apparatus 500 may be configured to implement the method described in the foregoing method embodiment. The apparatus 500 may be a chip, a terminal device, or a network device.

The apparatus 500 may include one or more processors 510. The processor 510 may support the apparatus 500 in implementing the method described in the foregoing method embodiment. The processor 510 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 500 may further include one or more memories 520. The memory 520 stores a program, and the program may be executed by the processor 510, so that the processor 510 executes the method described in the foregoing method embodiment. The memory 520 may be separate from the processor 510 or may be integrated into the processor 510.

The apparatus 500 may further include a transceiver 530. The processor 510 may communicate with another device or chip through the transceiver 530. For example, the processor 510 may transmit data to and receive data from another device or chip through the transceiver 530.

An embodiment of the present application further provides a computer-readable storage medium for storing a program. The computer-readable storage medium may be applied to the terminal or the network device provided in embodiments of the present application, and the program causes a computer to execute the methods performed by the terminal or the network device in various embodiments of the present application.

An embodiment of the present application further provides a computer program product. The computer program product includes a program. The computer program product may be applied to the terminal or the network device provided in embodiments of the present application, and the program causes a computer to execute the methods performed by the terminal or the network device in various embodiments of the present application.

An embodiment of the present application further provides a computer program. The computer program may be applied to a terminal or a network device provided in embodiments of the present application, and the computer program causes a computer to execute the methods performed by the terminal or the network device in various embodiments of the present application.

It should be understood that the terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular order. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “predefined” or “pre-configured” may be implemented by pre-storing corresponding code, tables, or other forms that may be used to indicate related information in devices (for example, including a terminal device and a network device), and a specific implementation thereof is not limited in the present application. For example, being pre-defined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In the embodiments of the present application, the “include” may refer to direct inclusion, or may refer to indirect inclusion. Optionally, the term “include” mentioned in the embodiments of the present application may be replaced with “indicate” or “be used to determine”. For example, A including B may be replaced with that A indicates B, or A is used to determine B.

In embodiments of the present application, sequence numbers of the foregoing processes do not mean execution sequences. The execution sequences of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

1-63. (canceled)

64. A method performed by a terminal device, comprising:
receiving a first signal and a second signal transmitted by a first device, wherein the first signal has a first transmit phase at the first device and the second signal has a second transmit phase at the first device, and wherein the first transmit phase and the second transmit phase satisfy a first relationship;
receiving assistance information, wherein the assistance information indicates the first relationship;
determining first phase information based on the first signal, the second signal and the assistance information, wherein the first phase information comprises a receive phase difference between the first signal and the second signal at the terminal device;
estimating a location of the terminal device based on the first phase information.

65. The method of claim 64, wherein the method further comprising: adjusting the receive phase difference based on the assistance information.

66. The method of claim 64, wherein the first relationship comprises at least one of: a transmit phase difference between the first signal and the second signal, or a time difference corresponding to the transmit phase difference.

67. The method of claim 66, wherein the transmit phase difference and the time difference satisfy:
transmit phase difference=mod(2πf*time difference, 2π), wherein f represents a carrier frequency of the first signal or the second signal, and mod ( ) represents a modulo operation.

68. The method of claim 65, wherein the transmit phase difference is zero.

69. The method of claim 64, wherein the first transmit phase and the second transmit phase are continuous in time, and wherein the first transmit phase and the second transmit phase satisfy:
Ø₂=mod(Ø₁+2πfΔt, 2π), wherein Ø₁ represents the first transmit phase, Ø₂ represents the second transmit phase, f represents a carrier frequency of the first signal or the second signal, Δt represents a time interval between transmission of the first signal and transmission of the second signal, and mod ( ) represents a modulo operation.

70. The method of claim 69, wherein adjusting the receive phase difference based on the assistance information comprises adjusting the receive phase difference by mod(2πfΔt, 2π).

71. The method of claim 64, further comprising:
determining that a speed of the terminal device is above a threshold speed; and
sending capability information to the first device, wherein the capability information is based on the determination that the speed of the terminal device is above the threshold speed, and wherein the capability information indicates that the terminal device does not support calculation of the receive phase difference based on the first signal and the second signal.

72. The method of claim 64, wherein the first signal comprises a first positioning reference signal (PRS) and the second signal comprises a second PRS.

73. The method of claim 64, wherein the first device is a non-terrestrial network (NTN) device.

74. A terminal device, comprising:
a transceiver configured to enable wireless communication with a first device; and a processor communicatively coupled to the transceiver and configured to:
receive a first signal and a second signal, wherein the first signal has a first transmit phase at the first device and the second signal has a second transmit phase at the first device, and wherein the first transmit phase and the second transmit phase satisfy a first relationship;
receive assistance information from the first device, wherein the assistance information indicates the first relationship;
determine first phase information based on the first signal, the second signal and the assistance information, wherein the first phase information comprises a receive phase difference between the first signal and the second signal at the terminal device; and
estimate a location of the terminal device based on the first phase information.

75. The terminal device of claim 74, wherein the processor is further configured to:
adjusting the receive phase difference based on the assistance information.

76. The terminal device of claim 74, wherein the first relationship comprises at least one of: a transmit phase difference between the first signal and the second signal, or a time difference corresponding to the transmit phase difference.

77. The terminal device of claim 76, wherein the transmit phase difference and the time difference satisfy:
transmit phase difference=mod(2πf*time difference, 2π), wherein f represents a carrier frequency of the first signal or the second signal, and mod ( ) represents a modulo operation.

78. The terminal device of claim 76, wherein the transmit phase difference is zero.

79. The terminal device of claim 74, wherein the first transmit phase and the second transmit phase are continuous in time, and wherein the first transmit phase and the second transmit phase satisfy:
Ø₂=mod(Ø₁+2πfΔt, 2π), wherein Ø₁ represents the first transmit phase, Ø₂ represents the second transmit phase, f represents a carrier frequency of the first signal or the second signal, Δt represents a time interval between transmission of the first signal and transmission of the second signal, and mod ( ) represents a modulo operation.

80. The terminal device of claim 79, wherein to adjust the receive phase difference based on the assistance information, the processor is further configured to adjust the receive phase difference by mod(2πfΔt, 2π).

81. The terminal of claim 74, wherein the processor is further configured to:
determine that a speed of the terminal device is above a threshold speed; and
send capability information to the first device, wherein the capability information is based on the determination that the speed of the terminal device is above the threshold speed, and wherein the capability information indicates the terminal device does not support calculation of the receive phase difference based on the first signal and the second signal.

82. The terminal device of claim 74, wherein the first signal comprises a first positioning reference signal (PRS) and the second signal comprises a second PRS.

83. The terminal device of claim 74, wherein the first device is a non-terrestrial network (NTN) device.
